(19) United States
(12) Patent Application Publication
(10) Pub. No.: US 2026/0320706 A1
(43) Pub. Date: Oct. 15, 2026

(54) TABLESIDE AI REVIEW SYSTEM

(71) Applicants: Zia Hasnain, San Jose, CA (US); Sohaib Shahid, Islamabad (PK); Syed Fakhir Ali, Islamabad (PK); Asad Bin Saif, Islamabad (PK)

(72) Inventors: Zia Hasnain, San Jose, CA (US); Sohaib Shahid, Islamabad (PK); Syed Fakhir Ali, Islamabad (PK); Asad Bin Saif, Islamabad (PK)

(73) Assignee: AIOAPP Inc., San Jose, CA (US)

(21) Appl. No.: 18/963,763

(22) Filed: Nov. 29, 2024

Related U.S. Application Data
(63) Continuation of application No. 29/922,206, filed on Dec. 21, 2023, now abandoned.
(63) Continuation of application No. 18/963,755, filed on Nov. 28, 2024, now Pat. No. 12,688,539.
(63) Continuation of application No. 18/963,761, filed on Nov. 29, 2024.
(60) Provisional application No. 63/607,574, filed on Dec. 8, 2023.
(60) Provisional application No. 63/561,805, filed on Mar. 6, 2024.
(60) Provisional application No. 63/561,809, filed on Mar. 6, 2024.
(60) Provisional application No. 63/561,799, filed on Mar. 6, 2024.
(60) Provisional application No. 63/573,509, filed on Apr. 3, 2024.
(60) Provisional application No. 63/573,510, filed on Apr. 3, 2024.

(51) Int. Cl. G06Q 50/12; G06F 40/295; G06F 40/30; G06Q 30/0601; G06V 40/16; G10L 15/22; G10L 15/26

(52) U.S. Cl. CPC G06Q 50/12; G06F 40/295; G06F 40/30; G06Q 30/06311; G06V 40/172; G10L 15/22; G10L 15/26

(57) ABSTRACT

The present disclosure pertains to a Tableside AI Review System capable of capturing customer reviews and feedback automatically in the hospitality industry. These powerful devices leverage microphone(s), camera(s), tablet processor, cloud computing, artificial intelligence, and computer vision technologies to assess the sentiment and aspect from the customer audio and video data captured at various intervals to detect the customer's review, feedback and reaction to food, services, and ambiance of any customer-facing business where customers are seated on a table for engagement.

### CROSS-REFERENCE TO RELATED APPLICATIONS

The present patent application is a continuation of U.S. Provisional Patent Application Ser. No. 63/607,574, filed on Dec. 12, 2023, and U.S. Design patent application Ser. No. 29/922,206, filed on Dec. 21, 2023, U.S. Provisional Patent Application Ser. No. 63/561,799, filed on Mar. 6, 2024, U.S. Provisional Patent Application Ser. No. 63/561,805, filed on Mar. 6, 2024, U.S. Provisional Patent Application Ser. No. 63/561,809, filed on Mar. 6, 2024, U.S. Provisional Patent Application Ser. No. 63/573,509, filed on Apr. 3, 2024, U.S. Provisional Patent Application Ser. No. 63/573,510 filed on Apr. 3, 2024, Non-Provisional patent application Ser. No. 18/963,755 filed on Nov. 29, 2024, Non-Provisional patent application Ser. No. 18/963,761 filed on Nov. 29, 2024, which are incorporated by reference herein in their entirety and for all purposes as if completely and fully set forth herein.

### FIELD OF INVENTION

The present invention relates to the field of natural language processing, speech and sentiment analysis, review analysis, technology, artificial intelligence, and the hospitality industry.

### BACKGROUND

Customer feedback holds immense significance for industries with direct customer interaction. This is particularly evident in establishments like restaurants, where reviews on food quality and ambiance serve as valuable touchpoints for fostering connections with patrons and cultivating loyalty. By actively integrating customer feedback into their operations, businesses can convey to customers that their opinions are not only heard but valued. This engagement not only heightens satisfaction but also contributes to the overall success of the enterprise. Positive reviews, in particular, serve as powerful tools for attracting new customers and establishing a foundation of trust.

However, obtaining customer feedback can be a challenge. Research indicates that dissatisfied customers often opt for silence rather than providing constructive feedback. A study by 1st Financial Training Services found that 96% of unhappy customers do not complain; however, 91% of those simply leave and never come back. According to Lee Resource International, for every customer who complains, there are twenty-six (26) other unhappy customers who have remained silent. The repercussions of this silence are far-reaching. The customers remain silent in terms of telling the management of a restaurant, bar, cafe, hotel, or resort, but not necessarily silent when it comes to telling others. This not only tarnishes the reputation of the establishment but also leads to a substantial loss of potential customers and revenue. Various factors contribute to this silence. A significant portion of customers (68%, as per a Rockefeller Corporation study) believe that their complaints will go unnoticed or unaddressed by the business, prompting them to sever ties. Others find the process of lodging a complaint cumbersome, assuming there is even a mechanism in place for such feedback. For industries like hospitality, where customer satisfaction is paramount, addressing this challenge is vital for staying competitive. The present invention, an artificially intelligent review system, is an innovative solution to automate customer feedback and review process which in turn acts as a strategic necessity for enhancing profitability and upholding a positive reputation. The present invention leverages advanced technology to quickly enable the management to assess real-time customer feedback-even of unsatisfied silent customers- and help resolve complaints.

### SUMMARY OF THE INVENTION

This summary provides a simplified form of concepts that are further described below in the detailed description. This summary is not intended to identify key or essential features and should therefore not be used for determining or limiting the scope of the claimed subject matter.

The present invention constitutes of a Tableside AI Device equipped with advanced sensors, artificial intelligence, cloud computing, and computer vision to automate the review and feedback process. The present invention can be utilized at any place where customer engagement requires a table, for example, restaurants, bars, cafes, hotels, or resorts. The present invention leverages facial and speech data and performs speech and sentiment analysis through artificial intelligence to capture reviews and feedback of customers. Furthermore, it enables prompt action by forwarding reviews to relevant staff and offers analytical insights for continuous improvement through a dedicated management app or dashboard.

### BRIEF DESCRIPTION OF THE DRAWINGS

The systems, methods, and computer program products disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates the high-level diagram of the abilities exhibited by, and modules contained in, the invention, including but not limited to, the Tableside AI Device, the Data Extraction and Review Assessment Module, the Aspect and Sentiment Analysis Module, the Solicited Review Module and Diagnosis Module.

FIG. 2 identifies the Tableside AI Device and the various components tethered there along with their functionality.

FIG. 3 illustrates the technical process and operation of the Data Extraction and Review Assessment Module, collection of audio and video data, transcription of audio data, and finally the determination of whether the speech contained any ‘review worthy’ text.

FIG. 4 illustrates the invention's Aspect and Sentiment Analysis Module whereby sentiment and aspect analysis are performed on review-worthy data by assessing facial expression, words, and tone to identify the customer's review or reaction.

FIG. 5 is a block diagram that streamlines the process involved in the invention's

Solicited Review Module whereby any review which is not conclusive is pushed through this module for certainty.

FIG. 6 outlines the Diagnosis Module of the invention whereby the system assesses and assigns potential reasons for the negative reviews recorded, makes improvement suggestions from automated and solicited reviews, and aids managers in decision-making for targeted enhancements.

### DETAILED DESCRIPTION OF THE INVENTION

In the following detailed description, numerous specific details are set forth by way of examples in order to provide a thorough understanding of the relevant teachings. However, it must be apparent to individuals skilled in the art that the present teachings may be practiced without such details. In other instances, well-known methods, procedures, and components have been described at a relatively high level, without detail, in order to avoid unnecessarily obscuring aspects of the present invention. Several descriptive terms and phrases are used in describing the various embodiments of this disclosure. These descriptive terms and phrases are used to convey generally agreed-upon meaning to those skilled in the art unless a different definition is given in this specification.

The present disclosure pertains to systems, methods, and computer program products in various embodiments for utilizing audio and visual data of the guests in the hospitality industry to perform various functions or services ordinarily performed by human helpers for management and quality assurance. The present disclosure may take the form of entirely a hardware embodiment, entirely a software embodiment (executed on hardware), entirely an Artificially Intelligent (AI) embodiment (integrated with software executed on hardware), or an embodiment combining AI, software, and hardware aspects that may all generally be referred to herein as a ‘Model’, ‘Device’, ‘Engine’, ‘Module’, ‘Component’ or ‘System’. A component of executable code may be a single instruction, or many instructions, and may even be distributed over several different code segments, among different programs, and across several memory devices. The operational data may be identified and illustrated herein within components and may be embodied in any suitable form and organized within any suitable type of data structure. The operational data may be collected as a single data set or may be distributed over different locations including over different storage devices. The data may be structured (e.g. tables, relational database, etc.) and unstructured (e.g., language text, pictures, etc.). Where a component or portions of a component are implemented in software, the software portions are stored on one or more non-transitory computer-readable storage media. A computer-readable storage medium may be, for example, an electronic, magnetic, optical, electromagnetic, infrared, or semiconductor system, apparatus, or device, or any suitable combination of the foregoing. The computer-readable storage media may be non-transitory and may be persistent.

The invention strategically deploys advanced technologies including (i) a microphone array as an audio receiver covering a radius of at least three (3) meters (ii) high-definition cameras measuring 720p to 1080p and covering a wide angle of 210 to 360 degrees for capturing videos and images (iii) a speaker to speak-out-loud responses generated by the System (iv) Natural Language Processing NLP-enabled voice recognition (v) video content processing face recognition (vi) a robust mesh network of interconnected devices, (vii) tablet receiver and processor and (viii) central AI-powered cloud processor and storage. The system deploys highly accurate facial recognition, tracking, feature extractions, and speech recognition components capable of being trained through machine learning models to recognize a wide variety of facial expressions, sentiments, vocabulary of words, associate tones, and other metadata, uniquely deployed in Video Content Analysis (VCA) and Speech-to-Text (STT) systems.

The present invention can be utilized in restaurants, bars, cafes, hotels, or resorts; however, to better understand the preferred embodiment, it will be described in this patent application in the context of a dine-in restaurant whereby it automates the process to capture customer feedback and reviews against various aspects of the restaurant including customer service, ambiance, food quality, and quantity. A customer interacts with the system according to embodiments through the microphone array and camera embedded in the Tableside AI Device. However, it is envisioned that the present system is otherwise configured to facilitate customer communication through a variety of electronic communication means including but not limited to touch screens.

The present disclosure pertains to the invention's Tableside AI Review System whereby it automates various aspects of obtaining and prompting customer reviews. The present disclosure pertains to the invention's Tableside AI Device; Data Extraction and Review Assessment Module; Aspect and Sentiment Analysis Module; Solicited Review Module and Diagnosis Module. However, the present invention contains other embodiments including the Tableside AI Waiter for Personalized Guest Experience, Tableside AI Audio and Visual Management System, Tableside AI Marketing System, and Tableside AI Device Protection and Monitoring System, all of which may form the subject matter of single or separate patent applications.

In the embodiment of the present disclosure, the database may contain a catalog of menu items and information about the restaurant including its services, ambiance, location, views etc. profiled in the database. In this embodiment, the catalog of items is obtained or imported from a Point-of-Sale (POS) system, a file containing structured text, a file containing unstructured text, or by scanning a physical copy or user input provided through a graphical user interface. The catalog of items displayed may be configured to communicate via video or audio or in a fixed form, which, based upon current technology, is preferably a menu display screen, for displaying, on one or more screens, a complete listing of all available menu items and options with their respective prices and other menu item information as desired.

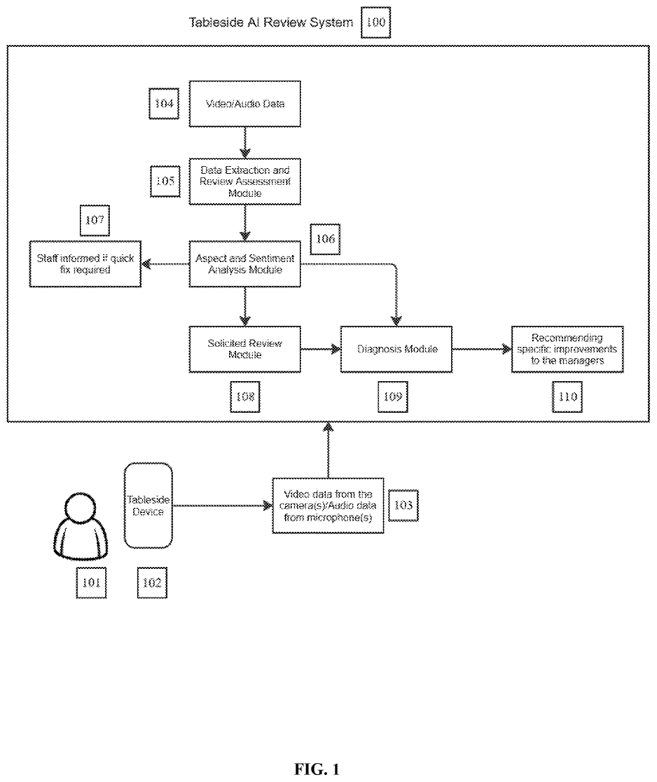

FIG. 1 shows the high-level diagram of various components of the Tableside AI Review System 100, including but not limited to, the Tableside AI Device 102; the Data Extraction and Review Assessment Module 105; the Aspect and Sentiment Analysis Module 106; the Solicited Review Module 108 and the Diagnosis Module 109. As customer 101 at a restaurant sits in front of the Tableside AI Device 102, the video and audio data are collected 103 and analyzed 104. Audio and video data of the customer can be collected at various intervals, including but not limited to, the time when the customer sits at the table, returns to the table after being seated, or when food/drinks are served. These trigger points or intervals to capture the data stream are customizable as per the management's discretion. The audio and video data 104 passes through the Data Extraction and Review Assessment Module 105, where relevant features are extracted, and the speech is converted to text and reviewed for worthy feedback. Where any portion of the text is considered ‘review worthy’ by the system, the Aspect and Sentiment Analysis Module 106 processes the extracted tone, text, and facial features to determine the aspect and sentiment of the customer. After applying the aspect and sentiment analysis to the textual data, the result thereof is an automated review. If all sentiments align i.e. tone, facial, and textual, the review is considered positive or negative. In case of a negative review and in case an immediate action is warranted i.e. something is missing in the order or case of some environmental issue, notifications are sent to relevant staff via POS, mPOS, or other communication devices 107. In case the sentiments do not align (the system cannot determine whether the outcome is positive or negative), the invention moves forward toward the Solicited Review Module 108 to cement the outcome of 106. Here at 108, the system leverages AI to prompt questions, direct or otherwise, to confirm the outcome of the automated review. The model can also ask multiple questions to extract the missing information necessary to reach a conclusive review. Finally, at 109, the system introduces the Diagnosis Module which uses intelligent machine-learning algorithms to detect underlying patterns or reasons associated with negative reviews, feedback, or sentiment and then leverages that data to recommend improvements to the management 110.

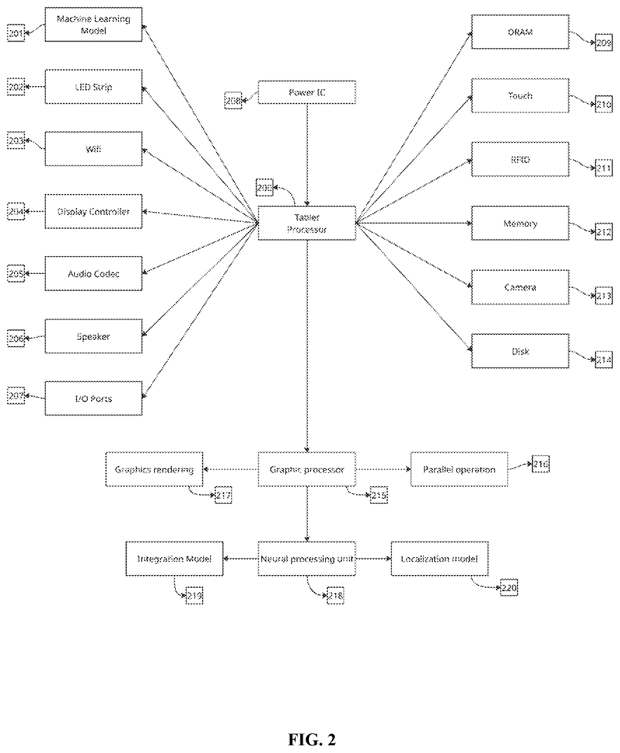

FIG. 2 demonstrates the various components of the Tableside AI Device 102, which lies at the heart of the invention and orchestrates the operations of all other components tethered thereto. The Tablet Processor 200 forms an integral part of, and is the core processor in, the Tableside AI Device 102. Attached to the Tablet Processor 200 are the relevant sensors mentioned earlier. On the upper-left side, 201 represents the “Machine Learning Model”, implying the tablet's capability to perform advanced computations using AI. The “LED strip” for customer engagement and response is attached at 202. The “WIFI” with Bluetooth module with 203, facilitates wireless connections to networks or devices. 204, the “Display Controller”, manages how content is shown on the device's screen. 205 is the “Audio Codec”, a vital component for managing sound by converting between digital and analog signals. 206 is the “Speaker” component to respond to the customer. At the lower-left corner, 207 represents the “I/O Ports”, permitting connectivity with external devices and peripherals. In the center, 208 is the “Power IC” for power connectivity and charging. Transitioning to the right side, 209 stands for the “DRAM”, a type of volatile memory known for its swift access times. 210 represents the “Touch” functionality, processing tactile interactions with the device. At 211 is the “RFID” to scan for the passive RFID tag on the table and prevent device theft or removal from the restaurant vicinity. 212 denotes the “Memory”, non-volatile, storing user data and applications. 213 is the “Camera”, the device's imaging module. 214 indicates the “Disk”, symbolizing long-term storage, in the form of an SSD or similar storage mediums. The graphics processing 215 unit is responsible for all the graphics renderings 217 on the device with the help of parallel processing 216. Neural processing unit 218 is responsible for the computations that are related to neural networks and machine learning models. Localization model 220 is being used to capture and localize the users voice and different integration models 219 are running on NPU to enhance the user experience. The Tablet Processor 200 plays a significant role in cleaning or refining the audio and video data captured through the relevant sensors. The Tablet Processor's machine learning model 201 perform complex calculations, including but not limited to, Fast Fourier transformation to check the spectrum of the signal. These models assess the amplitude levels and calculate the precise delay that each audio signal took to reach the AI device making sure that refined data is transferred to the cloud.

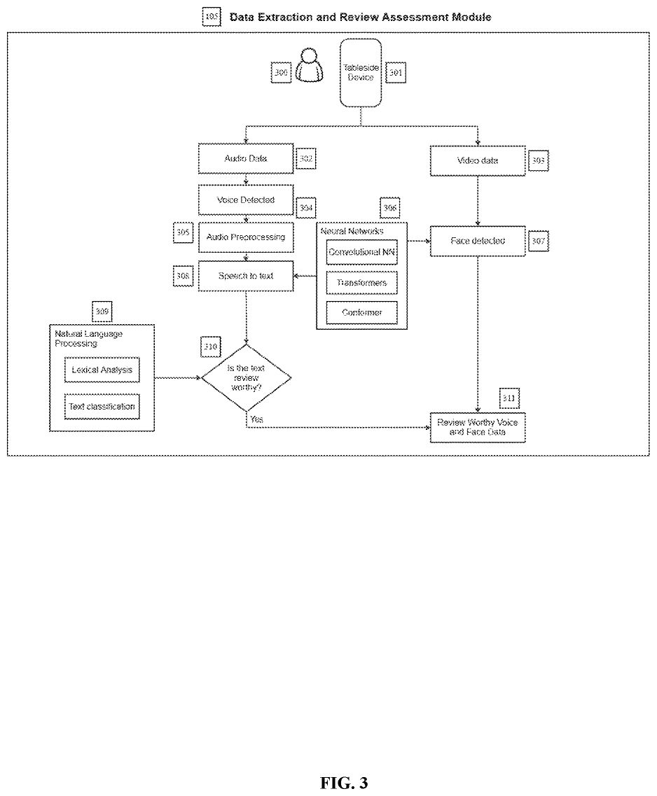

FIG. 3 illustrates the technical process involved in Data Extraction and Review Assessment Module 105. The process begins at 300 when a customer at a restaurant sits in front of the Tableside AI Device 301. Audio data 302 and video data 303 of customer 300 are captured at various intervals through the Tableside AI Device 301. As explained earlier, the intervals can be adjusted but are usually triggered, without limitation, when a customer is seated at the table, after the customer returns to the table, or when the food/drinks are served at the table. The audio data 302 and video data 303, captured from the same video stream, are processed simultaneously for feature extraction such as facial expression, voice, tone, and speech. The audio data 302 is processed for voice activity detection 304 whereby voice segments are extracted from the overall audio data 302. This segmentation or extraction can be performed by sending audio chunks through a Neural Network filter, such as Silero, whereby voice is extracted from the background noise. Subsequently, the extracted voice data 304 passes through a pre-processing stage 305 where sophisticated algorithms such as Fast Fourier Transform (FFT), Mel Spectrogram, and Mel Frequency Cepstral Coefficients (MFCC), are deployed and the data is pushed through the Neural Network architecture at 306 for voice tone detection and speech-to-text (STT) conversion 308. The STT conversion at 308 may be conducted either on-device, online, or on-premises. The transcribed text at 308 will then undergo Natural Language Processing 309 through lexical analysis and text classification using methods such as including N-gram Analysis, TF-IDF, and Word Embeddings to determine if it is deemed ‘review-worthy’ 310. The ‘review-worthy’ features in a restaurant for example may be categorized as food; including quality, taste, variety, and presentation, services; including efficiency and staff behavior, and ambiance; including cleanliness, views, and decor. Specific references to unique or signature dishes, responsiveness and professionalism of service, and distinctive atmosphere or thematic elements are indicators of aspects deemed important for reviews. Any data stream containing any representation or remark related to a review-worthy feature is isolated and forwarded, along with relevant video data, 311 to the Aspect and Sentimental Analysis Module 400. Simultaneously, video data 303 is processed and face detection algorithms are deployed 307 such as YOLO, histogram-oriented gradients, etc. to isolate faces from the video frames. This data is also forwarded to 311 for further processing through the Aspect and Sentimental Analysis Module 400.

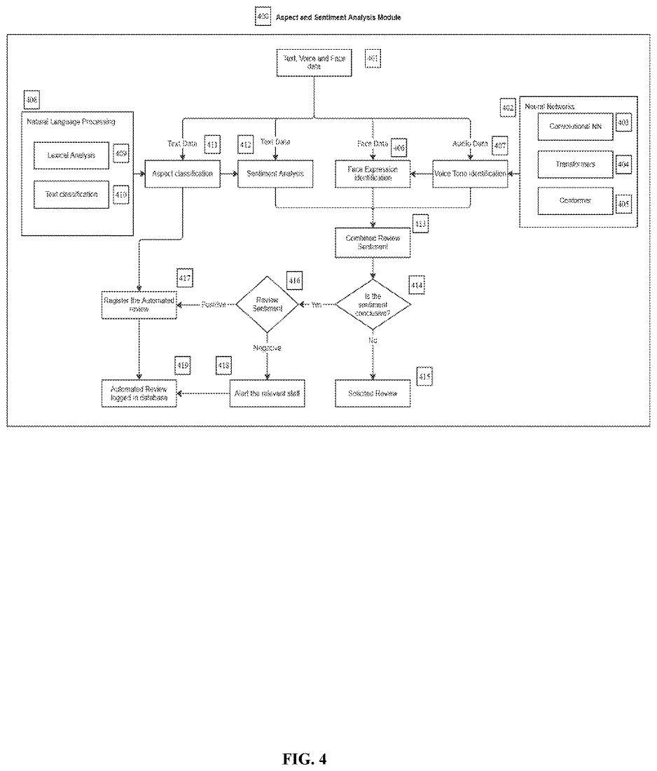

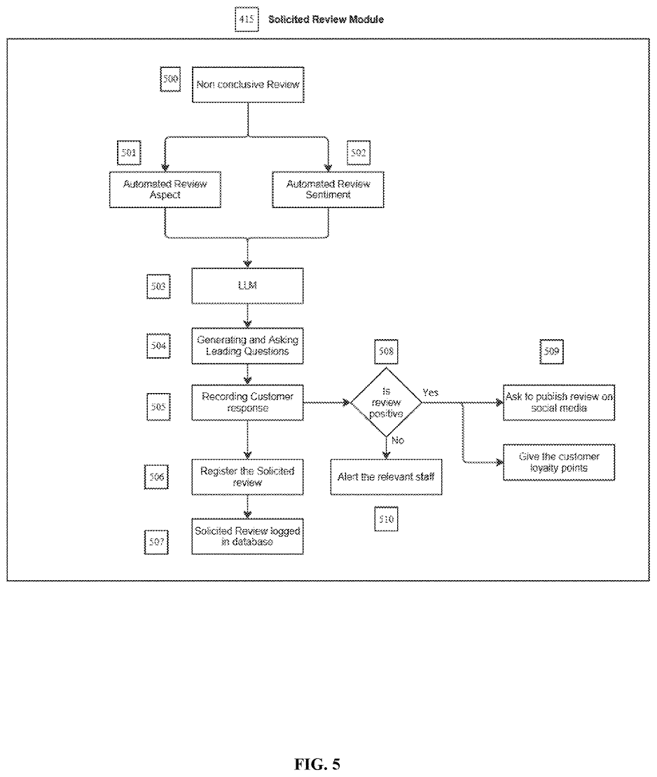

FIG. 4 represents the technical process of the invention's Aspect and Sentiment Analysis Module 400. The converted STT data along with voice and face data 401 are processed through Neural Networks 402 and Natural Language Processing 408. The Neural Network 402 comprising CNNs 403, Transformers 404, and Conformers 405—process face data and audio data to identify facial expressions 406 and tone of voice 407, respectively. In the alternative, vision transformers can also be used. At the same time, Natural Language Processing 408 through lexical analysis 409 and text classification 410 using methods such as Vector Embedding similarity algorithms, or text transformer models are used to determine the aspect classification 411 and Sentiment Analysis 412 from the text extracted from audio data at 401. At 413, the sentiment analysis 412, facial expressions 406, and voice tone 407 (412, 406, and 407 are collectively referred to as “Three Sentiment Variables”) are combined to determine the overall sentiment or reaction of the customer. At 414, the Combine Review Statement is assessed for conclusiveness 414 i.e. whether all Three Sentiment Variables are positive, all are negative, two are positive but one is negative or one is positive but two are negative. Conclusive sentiments are either when all Three Sentiment Variables are positive or negative. Conclusive sentiments are then reviewed at 416 to determine whether positive or negative to take appropriate action. In case of negative conclusive sentiment at 416, the review is considered negative, the restaurant staff is alerted 418 on POS or mPOS devices for immediate action, and the review is logged in database 419. In the case of the positive conclusive sentiment 417, the review is considered positive, combined with the aspect classification 411 and logged in database 419. Aspect classification is the relevant feature of an item in the catalog of items. For example, a customer orders an Angus Beef burger (item) from the menu (catalog of items) at a restaurant. On being served the same, the customer exclaims, “The beef is so tender and tasty!”. Here, all Three Sentiment Variables are positive, and the aspect is that the ‘beef is tender and tasty’. In the database, the system will log a positive review against the Angus Beef Burger and also attach the aspect that the ‘beef is tender and tasty’ with the Angus Beef Burger (item) in the menu (catalog of items). This automated individualized review or feedback of the customer against items in the catalog of items can be shared with third parties or advertised on the restaurant's website. In case the sentiment is not conclusive at 414, i.e. the Three Sentiment Variables are not entirely positive or negative, the system traverses to the Solicited Review 415 explained in FIG. 5 below.

FIG. 5 illustrates the invention's Solicited Review Module 415. If the review is non-conclusive at 414, the process begins at 500. Here, the review aspect 501 and review sentiment 502 are retrieved from the processes mentioned at 406, 407, and 412 and processed through an LLM at 503 to generate specific questions to confirm the review of the customer. In the same example of an Angus Beef burger, if on sentiment and aspect analysis, the customer's facial expression and words are positive but the tone is negative (non-conclusive review), the customer can be questioned if they liked the burger 504 generated by the LLM at 503. The response of the customer is recorded at 505. If the response is positive, the overall review is considered positive, conclusive, and logged at database 507. On positive review 508, the customer is asked if the same can be published on social media and the customer earns loyalty points 509. If the review is negative, the staff is alerted 510.

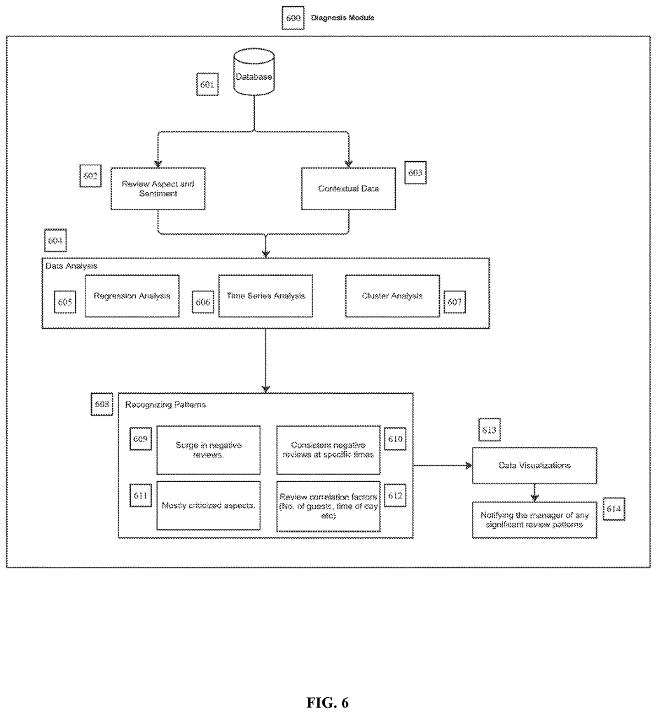

FIG. 6 represents the invention's Diagnosis Module 600. Here, the process begins with retrieving aspect and sentiment reviews 602 alongside contextual data 603 from a centralized database 601. The contextual data includes variables such as the number of guests at the table, date, time, and staff duties. These two streams of data are fed into a data analysis pipeline 604 which employs specific approaches such as regression analysis 605, time series analysis 606, and cluster analysis 607 to detect and interpret trends within the review data. The goal is to recognize patterns 608, such as spikes in negative feedback 609, pinpoint times when negative reviews are most frequent 610 and identify the most criticized aspects of the restaurant 611. It also assesses correlations 612 between the sentiment of the reviews and factors like number of guests, time of day etc. When significant review patterns are detected, the system notifies the restaurant manager 614, visually providing insights 613, in the form of graphs and charts, that could lead to operational improvements and enhanced customer satisfaction.

It is claimed is:

1. A Tableside artificially intelligent system for processing customer feedback through multimodal inputs in a customer-interactive environment/housed in a tableside device), the system comprising:
a processing subsystem comprising one or more tablet processors integrated with one or more machine learning models, one or more memory units configured to store raw and processed data, one or more input devices and one or more input/output devices each configured to communicate with the others;
a high-definition multi-touch display for user interaction;
a Wi-Fi module enabling low-latency, multi-node connectivity;
a 360-degree microphone array to capture audio data;
a set of high-definition cameras configured to provide panoramic video coverage of the surrounding area;
a neural processing unit configured for on-device AI computations, wherein the neural processing unit employs one or more AI models for voice activity detection, speech-to-text conversion, and localization to capture and interpret user voice inputs, along with one or more additional integration models to enhance user interaction;
a central cloud processor and storage system configured to host and execute AI models remotely and store relevant data;
a data extraction and review assessment module configured to perform feature extraction from audio and video data wherein the audio and video data is processed and analyzed via neural network architectures to identify review-worthy feedback;
an aspect and sentiment analysis module configured to perform sentiment analysis and aspect classification based on the transcribed text, voice, and face data, to record the customer's review;
a solicited review module configured to confirm an inconclusive review by generating follow-up questions and recording responses to the said questions when the aspects and sentiment analysis is inconclusive;
a diagnosis module configured to detect patterns in the customer's feedback by analyzing aspect and sentiment review data and contextual information from the database;
a backend database configured to store a plurality of raw and processed datasets including a catalog of menu items and contextual data including a restaurant's services, ambiance, location, views etc. profiled in the database;
a detachable wireless charging pad configured to support up to 15 Watts of wireless charging for compatible devices.

2. The tableside artificially intelligent system of claim 1, wherein the data extraction and review assessment module is further configured to initiate capturing audio and video data, based on customizable triggering events, wherein the triggering events may include a plurality of occurrences including, customer seating at a table, returning to the table, or serving of food or drinks.

3. The tableside artificially intelligent system of claim 1, wherein the data extraction and review assessment module further comprises an audio feature extraction unit configured to extract voice, speech, and tone from audio and video data using one or more AI-based audio processing algorithms wherein the audio data is first pre-processed using one or more audio pre-processing techniques.

4. The tableside artificially intelligent system of claim 1, wherein the data extraction and review assessment module further comprises a video feature extraction unit configured to analyze video data to extract facial expressions using one or more AI-based face and expressions detection algorithms, to identify a customer's sentiment from facial features and expressions.

5. The Tableside AI Review System of claim 1, wherein the data extraction and review assessment module further comprises a voice activity detection unit configured to segment voice data and isolate the voice data from background sounds using one or more neural network filters.

6. The Tableside AI System of claim 1, wherein the data extraction and review assessment module further comprises a speech-to-text conversion unit configured to transcribe isolated voice segments into text using any one or more of the on-device, online, or on-premise processing.

7. The Tableside AI System of claim 1, wherein the data extraction and review assessment module further comprises an AI-based topic modelling unit configured to analyze the transcribed text to detect keywords related to review-worthy aspects, including food quality, service efficiency, or ambiance.

8. The Tableside AI Review System of claim 1, wherein the aspect and sentiment analysis module further comprises one or more neural network architectures or one or more vision transformers configured to process the recorded facial expressions and processed audio data of the customer to determine the associated sentiments with the facial expressions and the voice tone of the customer.

9. The Tableside AI Review System of claim 1, wherein the aspect and sentiment analysis module further comprises a natural language processing unit configured to perform lexical analysis and text classification on the review-worthy aspects of the transcribed text to classify the identified aspects into predefined categories based on text sentiment analysis.

10. The Tableside AI Review System of claim 1, wherein the aspect and sentiment analysis module is further configured to combine the sentiment variables to determine an overall sentiment of the customer wherein the sentiment variables includes, facial expression, voice tone, and text sentiment data.

11. The Tableside AI Review System of claim 1, wherein the aspect and sentiment analysis module is further configured to record a customer sentiment, as positive conclusive sentiment wherein all variables are positive, negative conclusive sentiment when all sentiments are negative, or as inconclusive sentiment wherein the sentiment is neither conclusive positive sentiment or conclusive negative sentiment.

12. The Tableside AI Review System of claim 1, wherein the aspect and sentiment analysis module is further configured to generate an alert and transmit the alert to one or more connected devices upon detecting a negative conclusive sentiment.

13. The Tableside AI Review System of claim 1, wherein the aspect and sentiment analysis module is further configured to log conclusive reviews in a database, including specific aspects of customer feedback and a conclusive sentiment associated with corresponding items in the menu catalog.

14. The Tableside AI Review System of claim 1, wherein the solicited review module is further configured to process the non-conclusive review aspects and sentiments using one or more large language models to generate context-specific follow-up questions to confirm the customer's feedback wherein the customer's responses to the follow-up questions are recorded and processed further.

15. The Tableside AI Review System of claim 14, wherein the solicited review module is further configured to assess the customer's response to the follow-up questions as positive or negative and update the customer's original review as conclusive positive sentiment or conclusive negative sentiment in the database and wherein an alert is generated if a conclusive negative conclusive sentiment is determined.

16. The Tableside AI Review System of claim 1, wherein the solicited review module is further configured to prompt the customer for permission to publish a positive conclusive review on plurality of social media cites of the establishment and wherein loyalty points are assigned to the said customer upon receiving the approval.

17. The Tableside AI Review System of claim 1, wherein the diagnosis module is further configured to employ a plurality of data analysis techniques to analyse the stored review and contextual data to detect patterns, trends and correlations between customer reviews and contextual variables and wherein the insights are visualized in graphs and charts for operational improvements.

18. An artificially intelligent method for automating and analyzing customer reviews, embedded in a tableside device, the method comprising:
capturing audio and video streams based on adjustable triggering events, wherein the triggering events include customer seating, returning to the table, or serving of food or drinks and wherein the triggering events are adjustable based on pre-defined/specified occurrences;
extracting features from audio data, including voice, speech, and tone, using AI-based audio processing algorithms, wherein the audio data is segmented, transcribed and processed through neural network architectures to determine customer sentiment and review aspects;
extracting facial features from video data using one or more AI-based face detection algorithms or one or more vision algorithms to determine the customer sentiments;
combining sentiment variables, including facial expressions, voice tone, and text sentiments, to determine an overall conclusive sentiment of the customer;
generating context-specific follow-up questions if an inconclusive customer review is determined, with differing sentiments, wherein responses to the generated questions are recorded and processed to confirm/determine a conclusive review;
storing customer reviews, including sentiments linked to specific items in the menu and identified aspects related to the pre-defined categories, in the backend database; and
analysing the stored review data and contextual data using a plurality of data analysis techniques to detect patterns, trends, and correlations to generate operational insights.

19. The method of claim 18, wherein the audio data is processed using voice activity detection to isolate voice from background sounds, and wherein the isolated voice is further segmented into voice segments, using one or more neural network filters, to break down the speech into manageable units for further analysis.

20. The method of claim 18, wherein the audio processing further comprising transcribing the isolated and segmented voice into text, using one of the on-device, online, or on-premises speech-to-text processing.

21. The method of claim 18, wherein the transcribed text is analysed to detect review-worthy aspects using AI-based topic modeling, wherein keywords related to one of a plurality of aspects, including food quality, service efficiency, and ambiance are detected.

22. The method of claim 21, wherein the detected review-worthy aspects undergo lexical analysis and text classification to classify the identified aspects into predefined categories.

23. The method of claim 18, wherein feature extraction from audio and video data further comprising processing facial expressions and voice features of the customer using one or more neural network architectures or vision transformers to determine sentiments associated with the facial expressions and voice features.

24. The method of claim 18, further comprising combining sentiment variables, including facial expression, voice tone, and text sentiment data, to determine an overall sentiment of the customer.

25. The method of claim 18, further comprising recording a conclusive customer sentiment when sentiment variables, including facial expressions, voice tone, and text sentiment, are either all positive or all negative, and recording an inconclusive sentiment wherein the sentiment variables indicate differing or conflicting sentiments.

26. The method of claim 18, further comprising generating an alert upon detecting a negative conclusive sentiment and transmitting the alert to one or more connected devices.

27. The method of claim 18, further comprising storing conclusive reviews in a database, wherein the conclusive reviews include specific aspects of customer feedback and conclusive sentiments associated with corresponding items in a menu catalog.

28. The method of claim 18, further comprising processing non-conclusive review, with differing aspects and sentiment variables, using one or more large language models wherein context-specific follow-up questions are generated to confirm the review and wherein the feedback to the follow up questions is recorded for further analysis.

29. The method of claim 28, further comprising classifying the customer's review as conclusive based on the recorded feedback to follow up questions, wherein the customer review status is updated to positive or negative in the database, and wherein an alert is generated upon determining a negative conclusive sentiment.

30. The method of claim 29, further comprising prompting the customer for permission to publish a positive conclusive review on one or more social media sites of the establishment and wherein loyalty points are assigned to the customer upon receiving the approval.

31. The method of claim 18, further comprising analyzing stored review and contextual data using a plurality of data analysis techniques to detect patterns, trends, and correlations between customer reviews and contextual variables wherein the insights are visualized in the form of graphs and charts to support operational improvements.
